(19) United States
(12) Patent Application Publication
(10) Pub. No.: US 2016/0075159 A1
(43) Pub. Date: Mar. 17, 2016

(54) PRINTABLE RECORDING MEDIA

(71) Applicant: HEWLETT-PACKARD DEVELOPMENT COMPANY, L.P., Houston, TX (US)

(72) Inventors: Xi Zeng, JR., San Diego, CA (US); Lokendra Pal, San Diego, CA (US); Rajasekar Vaidyanathan, San Diego, CA (US)

(21) Appl. No.: 14/786,866

(22) PCT Filed: Apr. 24, 2013
(86) PCT No.: PCT/US13/37946

§ 371 Date: Oct. 23, 2015

(51) Int. Cl. B41M 5/52; B41M 5/50

(52) U.S. Cl. CPC B41M 5/5218; B41M 5/506; B41M 2205/38

(57) ABSTRACT

A printable recording media containing a base substrate; a pre-coat layer including more than about 60 wt % of one or more particulate inorganic pigments by total dry weight of said pre-coat layer; an ink-receiving layer, disposed on said pre-coat layer, comprising a mixture of about 10 to about 90 wt % of a first pigment including precipitated calcium carbonate particles, about 5 to about 60 wt % of a second pigment having a larger size and a different shape than said first pigment particles, and about 1 to about 50 wt % of a third pigment having a surface area of at least 50 m2/gram, wherein said weight percentages are by combined weight of the first, second and third pigments by total dry weight of said ink-receiving layer. Also disclosed herein is a method for producing printed images using said recording media.

### BACKGROUND

Inkjet printing is a non-impact printing method in which an electronic signal controls and directs droplets or a stream of ink that can be deposited on a variety of substrates. Current inkjet printing technology involves forcing the ink drops through small nozzles by thermal ejection, piezoelectric pressure or oscillation, onto the surface of a media. This technology has become a popular way of recording images on various media surfaces, particularly paper, for a number of reasons, including low printer noise, capability of high-speed recording and multi-color recording. Inkjet web printing is a technology that is specifically well adapted for commercial and industrial printing. Though there has been great improvement in high-speed inkjet printing, improvements are followed by increased demands regarding higher resolution, increased durability and ability to print on specific recording substrates. The printable recording media that are used on these printing processes should have thus excellent properties: they should be able, for example, to have a fast ink absorption (which enables fast drying in a short drying unit with elevated temperature) while, at the same time, generating an excellent image quality.

### BRIEF DESCRIPTION OF THE DRAWING

The drawings illustrate various embodiments of the present recording media and are part of the specification.

FIGS. 1 and 2 are cross-sectional views of the printable recording media according to embodiments of the present disclosure.

FIG. 3 is a flowchart illustrating the method for producing durable images according to some embodiments of the present disclosure.

### DETAILED DESCRIPTION

Before particular embodiments of the present disclosure are disclosed and described, it is to be understood that the present disclosure is not limited to the particular process and materials disclosed herein. It is also to be understood that the terminology used herein is used for describing particular embodiments only and is not intended to be limiting, as the scope of protection will be defined by the claims and equivalents thereof. In describing and claiming the present media and method, the following terminology will be used: the singular forms “a”, “an”, and “the” include plural referents unless the context clearly dictates otherwise. Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For examples, a weight range of about 1 wt % to about 20 wt % should be interpreted to include not only the explicitly recited concentration limits of 1 wt % to 20 wt %, but also to include individual concentrations such as 2 wt %, 3 wt %, 4 wt %, and sub-ranges such as 5 wt % to 15 wt %, 10 wt % to 20 wt %, etc. All percents are by weight (wt %) unless otherwise indicated. As used herein, “image” refers to marks, signs, symbols, figures, indications, and/or appearances deposited upon a material or substrate with either visible or an invisible ink composition. Examples of an image can include characters, words, numbers, alphanumeric symbols, punctuation, text, lines, underlines, highlights, and the like.

The present disclosure refers to printable recording media containing a base substrate; a pre-coat layer including more than about 60 wt % of one or more particulate inorganic pigments by total dry weight of said pre-coat layer; an ink-receiving layer, disposed on said pre-coat layer, comprising a mixture of about 10 to about 90 wt % of a first pigment including precipitated calcium carbonate particles, about 5 to about 60 wt % of a second pigment having a larger size and a different shape than said first pigment particles, and about 1 to about 50 wt % of a third pigment having a surface area of at least 50 m²/gram, wherein said weight percentages are by combined weight of the first, second and third pigments by total dry weight of said ink-receiving layer. The present disclosure refers also to a method for producing printed images using said recording media.

### The Printable Recording Media

The printable recording media, described herein, provides printed images and articles that demonstrate excellent image quality (good bleed and coalescence performance) and enhance durability performance while enabling high-speed and very high-speed printing. By high-speed printing, it is meant herein that the printing method can be done at a speed of 50 fpm or higher. As durability performance, it is meant herein that the resulting printed images are robust to dry and wet rubbing that can be done by going through finishing equipment (slitting, sheeting, folding, etc.) or by the user.

The printable recording media provides printed images that do not show visible print mottle. Print mottle or mottling is a defect that often presents as uneven random color patterns in a large area of an image. It is believed that uneven absorption of ink vehicle in the coating layer causes this defect, a result of uneven coat weight/thickness on base paper, and/or variation of pore structure in the coating layer. For coated paper, the underneath base paper is usually rougher than the final sheets. During coating process, the thickness of the coating layer may vary with any bumps and valleys on the base paper surface. Even with precise coating methods, there is often uneven coating thickness across the web. Since the absorption of liquid in coating layer is different than absorption in the base paper, variation of the coat weight is a major cause of print mottle. In addition, coated paper usually goes through a calender or super calender step after the coating process in order to produce a smother surface and/or higher gloss products. Under pressure and/or high temperature, the pores in the coating layer will deform. Due to uneven base paper and variation of coating thickness, calendering can easily cause differences in pore structure, i.e., patterns of pore size distribution and pore shape. Such differences might, in many cases, cause variation of ink penetration rate in the coating layer, and eventually exacerbate a print mottle defect. In addition, the printable recording media has, in the same time, excellent surface smoothness and a high absorptivity. The resulting printed article and image have, therefore, outstanding print durability and print quality.

In some examples, the printable recording media described herein is a coated dull media that can print at speeds needed for commercial and other printers such as, for example, a Hewlett Packard (HP) Inkjet Web Press (Hewlett Packard Inc., Palo Alto, Calif., USA). The properties of such printable recording media are comparable to coated media for offset printing.

The printable media has a fast absorption rate. By “fast absorption rate”, it is meant that the water, solvent and/or vehicle of the ink can be absorbed by the media at a fast rate so that the ink composition does not have a chance to interact and cause bleed and/or coalescence issues. The absorption rate that defects free printing is dependent on the speed of the printing and amount of ink being used. The faster the printing speed and the higher the amount of ink used, the higher is the demand on faster absorption from the media. A good diagnostic plot with maximum ink density, especially secondary colors, would be prone to coalescence and a pattern of lines of all primary and secondary colors passing through area fills of primary and secondary colors would be prone to bleed. If no bleed or coalescence is present at the desired printing speed, the absorption rate would be sufficient. Bristow wheel measurements can be used for a quantitative measure of absorption on media wherein a fixed amount of a fluid is applied through a slit to a strip of media that moves at varying speeds.

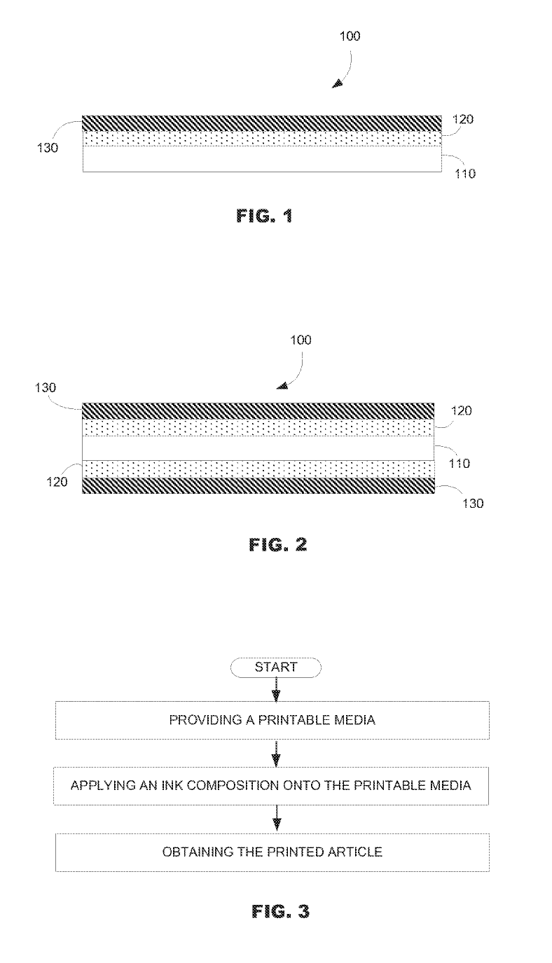

FIG. 1 and FIG. 2 illustrate the printable recording media (100) as described herein. As illustrated in FIG. 1, the printable media (100) encompasses a bottom supporting substrate (110), a pre-coat layer (120) and an ink-receiving layer (130). The pre-coat layer (120) is applied on one side of the bottom supporting substrate (110). The ink-receiving layer (130) is applied over the pre-coat layer (120). If said coated side is used as an image-receiving side, the other side, i.e. backside, may not have any coating at all, or may be coated with other chemicals (e.g. sizing agents) or coatings to meet certain features such as to balance the curl of the final product or to improve sheet feeding in printer. In some examples, such as illustrated in FIG. 2, the pre-coat layer (120) and the ink-receiving layer (130) are applied to both opposing sides of the supporting substrate (110). The double-side coated media has thus a sandwich structure, i.e. both sides of the supporting substrate (110) are coated with the same coating and both sides may be printed.

An amount of the pre-coat layer and an amount of the ink-receiving layer on the print media in the dry state is, at least, sufficient to hold all of the ink that is to be applied to the print media. The supporting substrate (110) can have a thickness along substantially the entire length ranging between about 0.025 mm and about 0.5 mm.

In some examples, the pre-coat layer (120) is disposed on the supporting substrate (110) and forms a coating layer having a coat-weight in the range of about 1 to about 30 gram per square meter (g/m² or gsm) per side, or in the range of about 5 to about 20 gsm, or in the range of about 8 to about 15 gsm per side. In some examples, the ink-receiving layer (130) is disposed on the supporting substrate (110), above the pre-coat layer (120), and forms a coating layer having a coat-weight which is above 5 gsm (gram per square meter or g/m²) per side, or, in some other examples, which is above 15 gsm (gram per square meter) on, at least, one side of the media. In yet some other examples, the ink-receiving layer (130) has a coat-weight in the range of about 15 to about 30 gsm. The printable recording media can have a pre-coat layer, on a side of the printable recording media, with a coat-weight of about 5 to about 20 gsm and an ink-receiving layer, on the same side of the printable recording media, with a coat-weight of about 15 to about 30 gsm.

### The Base Substrate

As illustrated in FIG. 1, the printable media (100) contains a base substrate (110) that supports a pre-coat layer (120) and an ink-receiving layer (130) and that acts as a bottom substrate layer. Such base print media substrate (i.e. substrate or base substrate) contains a material that serves as a base upon which the pre-coat layer and the ink-receiving layer are applied. The base substrate provides integrity for the resultant printable media.

The base substrate may include any materials which can support a coating composition, for example, natural materials, such as a base including cellulose fibers, or synthetic material, such as a base including synthetic polymeric fibers, or non-fabric materials such as a polymeric film, or a mixture of them. The base substrate material has good affinity and good compatibility for the ink that is applied to the material.

Examples of substrates include, but are not limited to, natural cellulosic material, synthetic cellulosic material (such as, for example, cellulose diacetate, cellulose triacetate, cellulose propionate, cellulose butyrate, cellulose acetate butyrate and nitrocellulose), material including one or more polymers such as, for example, polyolefins, polyesters, polyamides, ethylene copolymers, polycarbonates, polyurethanes, polyalkylene oxides, polyester amides, polyethylene terephthalate, polyethylene, polystyrene, polypropylene, polycarbonate, polyvinyl acetal, polyalkyloxazolines, polyphenyl oxazolines, polyethylene-imines, polyvinyl pyrrolidones, and combinations of two or more of the above. In some examples, the print media substrate includes a paper base including paper, cardboard, paperboard, paper laminated with plastics, and paper coated with resin. The base substrate may include polymeric binders. Such polymeric binder may be included, for example, when non-cellulose fibers are used. The base substrate may include cellulose fibers and synthetic fibers. The cellulose fibers may be made from hardwood or softwood species. The fibers of the substrate material may be produced from chemical pulp, mechanical pulp, thermal mechanical pulp, chemical mechanical pulp or chemical thermo-mechanical pulp. Examples of wood pulps include, but are not limited to, kraft pulps and sulfite pulps, each of which may or may not be bleached. Examples of softwoods include, but are not limited to, pine, spruce and hemlock. Examples of hardwoods include, but are not limited to, birch, maple, oak, poplar and aspen. The synthetic fibers may be made from polymerization of organic monomers. The base substrate may also include non-cellulose fibers.

The basis weight of the print media substrate is dependent on the nature of the application of the print media where lighter weights are employed for magazines, books and tri-folds brochures and heavier weights are employed for post cards and packaging applications, for example. In some examples, the substrate has a basis weight of about 60 grams per square meter (g/m² or gsm) to about 400 gsm, or about 100 gsm to about 250 gsm.

### The Pre-Coat Layer

The printable media contains a pre-coat layer (120) disposed onto the base substrate (110). Without being limited by any theory, it is believed that said pre-coat layer is designed to reduce the roughness of the base substrate, and help to create a “uniform” coating layer, that will reduce the print image mottle. Said pre-coat layer is designed to provide a “high” absorption rate of the inks that is deposited thereon and to allow thus good bleed and coalescence performance. In some example, said pre-coat layer (120) is present on, at least, one side of the print media substrate. In some other examples, the pre-coat layer (120) is present on both side of the print media substrate.

The pre-coat layer (120) contains more than about 60 wt % of one or more particulate inorganic pigments by total dry weight of said pre-coat layer. In some other examples, the pre-coat layer (120) contains more than about 80 wt % of one or more particulate inorganic pigments by total dry weight of the pre-coat layer. The pre-coat layer (120) can include inorganic pigments in particulate form and, at least, one binder.

In some examples, the average particle size of the particulate inorganic pigments, that are present in the pre-coat layer (120), is in the range of about 0.5 to about 10 microns (μm). “Particle size” refers to the diameter of a particle as if the particle were spherical. “Average particle size” refers to the sum of all of the sizes of the particles divided by the total number of particles.

The particulate inorganic pigments, present in the pre-coat layer (120) can be precipitated calcium carbonate, modified calcium carbonate, ground calcium carbonate, kaolin clay, hydrated clay, engineered clay, calcined clay or a mixture of any of them. The particulate inorganic pigments, present in the pre-coat layer (120) can also be calcined clay, ultra-fine precipitated calcium carbonate, modified calcium carbonate, ground calcium carbonate or combinations thereof. In some examples, the particulate inorganic pigments, present in the pre-coat layer (120), are combinations of calcined clay and precipitated calcium carbonate.

The particulate inorganic pigment, by way of illustration and not limitation, can be Kaocal® calcined clay (particle size distribution of about 83-92% particles finer than 2 μm) (from Thiele Kaolin Company, Sandersville Ga.); Omyajet® B5260 ultrafine precipitated calcium carbonate (average particle size of about 2.4 μm) (from Omya Inc., Florence Vt.); or a mixture of Kaocal® calcined clay and Hydrocarb® 60 fine ground calcium carbonate (average particle size of about 1.5 μm) (from Omya Inc.) wherein the mixture contains, by dry weight, at least about 50%, or at least about 80%, of Kaocal® calcined clay, for example. It is believed that higher level of calcined clay provides higher absorption for bleed control at high speed printing. The second pigment particulate can be added to help improve the coating application process.

In some examples, the pre-coat layer further includes one or more polymeric binders in an amount representing from of about 2 wt % to about 25 wt % or, in some other example, in an amount representing from about 5 wt % to about 10 wt % by total dry weight of the pre-coat layer. Such polymeric binders are water-soluble or water-dispersible binders or a combination thereof.

Some examples of polymeric binder include but are not limited to polyvinyl alcohol or derivatives thereof, polyethylene glycol or derivatives thereof, polyurethane, polyvinylpyrrolidone, starch or derivatives thereof, gelatin or derivatives thereof, cellulose or derivatives thereof, maleic anhydride polymers or copolymers, acrylic ester polymer and copolymers, polymethylacrylate or copolymers, polyacrylamide, latex resin materials based on polymers or copolymers of styrene butadiene, acrylic, styrene acrylic, styrene methylacrylate, styrene acrylonitrile, styrene/maleic anhydride, vinyl acrylic, vinyl acetate, vinyl esters, vinyl ethers, or a mixture of any of them. The polymeric binder may be, but is not limited to, latex polymers, polyvinyl alcohols and polyvinyl pyrrolidones. The latex polymer may be derived from a number of monomers such as, by way of example and not limitation, vinyl monomers, allylic monomers, olefins, and unsaturated hydrocarbons, and mixtures thereof. Classes of vinyl monomers include, but are not limited to, vinyl aromatic monomers (e.g., styrene), vinyl aliphatic monomers (e.g., butadiene), vinyl alcohols, vinyl halides, vinyl esters of carboxylic acids (e.g., vinyl acetate), vinyl ethers, (meth)acrylic acid, (meth)acrylates, (meth)acrylamides, (meth)acrylonitriles, and mixtures of two or more of the above, for example. The term “(meth)acrylic latex” includes polymers of acrylic monomers, polymers of methacrylic monomers, and copolymers of the aforementioned monomers with other monomers.

In some embodiments, the polymeric binder is a latex polymer binder. Examples of vinyl aromatic monomers that may form the latex polymeric binder include, but are not limited to, styrene, 3-methylstyrene, 4-methylstyrene, styrene-butadiene, p-chloro-methylstyrene, 2-chlorostyrene, 3-chlorostyrene, 4-chlorostyrene, divinyl benzene, vinyl naphthalene and divinyl naphthalene. Vinyl halides that may be used include, but are not limited to, vinyl chloride and vinylidene fluoride. Vinyl esters of carboxylic acids that may be used include, but are not limited to, vinyl acetate, vinyl butyrate, vinyl methacrylate, vinyl 3,4-dimethoxybenzoate, vinyl malate and vinyl benzoate. Examples of vinyl ethers that may be employed include, but are not limited to, butyl vinyl ether and propyl vinyl ether, for example. In some examples, the binder may be a styrene/butadiene latex copolymer. In some other examples, the binder may be a styrene/butadiene/acrylonitrile latex copolymer. The latex polymer can be, but is not limited to, Gencryl®9525 styrene/butadiene/acrylonitrile copolymer (from RohmNova, Akron Ohio), Gencryl®9750 styrene/butadiene/acrylonitrile (from RohmNova), STR 5401 styrene/butadiene (from Dow Chemical Company, Midland Mich.), Mowiol®4-98 polyvinyl alcohol (Kuraray America, Inc., Houston Tex.), for example, or a combination of two or more of the above.

Other components that may be present in a composition for forming a pre-coat layer in accordance with the principles described herein include one or more additives affecting various properties of the composition. The additives include, but are not limited to, one or more of rheology modifiers, thickening agents, cross-linking agents, surfactants, defoamers, optical brighteners, dyes, pH controlling agents or wetting agents, and dispersing agents, for example. The total amount, by weight, of additives, in the composition for forming the pre-coat layer, can be from about 0.1 wt % to about 5 wt %, or from about 0.2 wt % to about 3 wt %, by total dry weight of the pre-coat layer.

A combination of a particle size and a coat-weight of the pre-coat and ink-receiving layer, on the printable recording media, yields to pore size distribution in the range of about 0.025 microns (μm) to about 1.0 microns (μm). In some examples, the pore size distribution is in the range of about 0.05 microns (μm) to about 0.5 microns (μm). In some other examples, the pore size distribution is in the range of about 0.08 microns (μm) to about 0.3 microns (μm). The phrase “pore size” refers to the pores that are formed by a particulate inorganic pigment associated with a print media substrate. The pores are formed by a combination of an average particle size of the particulate inorganic pigment, a particle size distribution of the particulate inorganic pigment and a coat-weight of the particulate inorganic pigment. “Particle size distribution” refers to the percentage of particles falling within a particular size range. For purposes of illustration and not limitation, an example is a particle size distribution where about 75% to about 85% of the particles have a particle size in a range of about 1.0 to about 1.4 microns (μm).

### The Ink-Receiving Layer

The printable media contains an ink-receiving layer (130), disposed on the pre-coat layer (120). Said ink-receiving layer (130) can be present on, at least, one side of the printable media or on both sides. The ink-receptive layer (130) includes a coating formula with at least three different kinds of inorganic pigment, including a first pigment of precipitated calcium carbonate (PCC), a second inorganic pigment with different average particle size and morphology than the first pigment, and a third inorganic pigment with a surface-area of at least 50 m²/g. Such ink-receiving layer (130) encompasses: from about 10 to about 90 wt % of a first pigment including precipitated calcium carbonate particles; from about 5 to about 60 wt % of a second pigment having a larger size and a different shape than said first pigment particles; and from about 1 to about 50 wt % of a third pigment comprising particles of a liquid absorptive high surface area material having a surface area of at least 50 m²/gram, wherein said weight percentages are by combined weight of the first, second and third pigments by total dry weight of said ink-receiving layer.

In some examples, the first pigment, present in the ink-receiving layer (130), is precipitated calcium carbonate (PCC) particles with narrow size-distribution. Such precipitated calcium carbonate (PCC) particles can have an average particle size of less than 1 micron, or less than about 400 nm or even smaller. PCC particles, in the specified size ranges, may be prepared in accordance with methods that are described in the literature, such as, for example, in the Chapter 2, of “The Coating Processes” (edited by J. C. Walter, Tappi Press, Atlanta, Ga., 1993). The first pigment can be, for examples, Opacarb®A40 (from BASF). In some examples, the first pigment, of the ink-receiving layer, is present in an amount representing from about 10 to about 90 wt %; or, in some other examples, in an amount representing from about 25 to about 75 wt %; or, in yet some other examples, in an amount representing from about 30 to about 65 wt % of the total weight of said ink-receiving layer

The second pigment, that is present in the ink-receiving layer (130) has different shape and particle size, compared to the PCC particles. Without wishing to be limited to any theory, it is believed that inclusion of the second pigment disrupts the packing structure of PCC particles in coating layer, creating voids between particles that enhance the flow and storage of liquid. The second pigment can be a ground calcium carbonate (GCC) pigment, or clay pigment such as kaolin clay, hydrated clay, calcined clay, or other material that is capable of functioning in a similar manner. In some examples, the second pigment has a larger particle size and a different shape than the PCC pigment. In some embodiments, the average particle size of the second pigment is in the range of about 0.5 to about 10 μm. In certain instances, the second pigment's size is in the range of about 0.5 to about 5 μm, and, in some cases, in the range of about 0.8 to about 2 μm in size. Ground calcium carbonate (GCC) and platey clay particles, in the specified size ranges, may be prepared in accordance with methods that are, for example, as described in Chapter 2, in “The Coating Processes” (edited by J. C. Walter, Tappi Press, Atlanta, Ga., 1993).

In some examples, the second pigment, present in the ink-receiving layer (130), is a clay pigment, especially a clay pigment with a high aspect ratio, sometimes referred to as “platey clay.” Platey clays have a planar shape, with dimensions ranging from submicron up to several microns, or even up to more than 10 microns. In some other examples, the second pigment is calcined clay. In yet some other examples, the second pigment is a combination of ground calcium carbonate (GCC) particles and platey clay. The weight ratio between GCC particles and platey clay can be in the range of from 1:5 to 5:1.

The second pigment is present, in the ink-receiving layer (130), in an amount representing from about 5 to about 60 wt %; or, in some other examples, in an amount representing from about 10 to about 50 wt %; or, in yet some other examples, in an amount representing from about 20 to about 40 wt % based on the total weight of the ink-receiving layer.

The third pigment includes particles of a liquid absorptive high surface area material having a surface area of at least 50 m²/gram. In some examples, the third pigment has a higher surface area than the first and second pigments. Suitable materials for the third pigment particles include, but are not limited to, fumed silica, silica gel, colloidal silica, zeolite, alumina, although any another suitable material capable of functioning similarly to those materials could be used. For example, materials with nano-meter scale structure, such as the engineered calcium carbonate Omyajet® (Omya Corporation, Alpharetta, Ga.) may serve as the third pigment in some instances. Omyajet® is a specialty ground calcium carbonate pigment. Its surface has been through special treatment to increase surface area and liquid absorption rate, to a high BET surface area of about 50 m²/g. In some examples, the third pigment is present, in the ink-receiving layer, in an amount representing from about 1 to about 50 wt % of the total weight of said ink-receiving layer; in some other examples, in an amount representing from about 5 to about 40 wt %; or, in yet some other example, in an amount representing from about 10 to about 25 wt % of the total weight of said ink-receiving layer.

In some examples, the third pigment is a silica pigment. Silica pigment includes but is not limited to fumed silica, silica gel, colloidal silica, or precipitated silica. In the coating formula, silica pigment could be from a single source in a powder form or in a slurry form, or a mixture of any two or more different kinds of silica particles in powder or slurry form. Silica can be used as a third pigment, in order, for examples, to improve rub resistance and reduces high-lighter smear of printed sheets.

The ink-receiving layer might further encompass a polymeric binder in an amount representing from about 2 wt % to about 20 wt %, or representing from about 4% to about 10%, by total dry weight of the ink-receiving layer. The polymeric binder may be any one of the polymeric binders listed above for the pre-coat layer or combinations of two or more thereof.

In some examples, the polymeric binder is a water-soluble binder or a water-dispersible binder. Some examples of such a binder are included but not limited to polyvinyl alcohol or derivatives thereof, polyethylene glycol or derivatives thereof, polyurethane, polyvinylpyrrolidone, starch or derivatives thereof, gelatin or derivatives thereof, cellulose or derivatives thereof, maleic anhydride polymers or copolymers, acrylic ester polymer and copolymers, polymethylacrylate or copolymers, polyacrylamide, latex resin materials based on polymers or copolymers of styrene butadiene, acrylic, styrene acrylic, styrene methylacrylate, styrene acrylonitrile, styrene/maleic anhydride, vinyl acrylic, vinyl acetate, vinyl esters, vinyl ethers, or a mix of any of them.

In addition to the above-described three pigments and potential binders, the ink-receiving layer formulations might also contain other components, as necessary, to carry out the required mixing, coating, manufacturing, and other process steps, as well as to satisfy other requirements of the finished product, depending on its intended use. The ink-receiving layer might thus further contain other components such as surfactants, binders, rheology modifiers, defoamers, optical brighteners, dyes, pH controlling agents, and any other components suitable for forming the coating layer on paper substrate.

### Method for Producing the Coated Media

Both the pre-coat layer (120) and the ink-receptive layer (130) can be applied to the base substrate (110) by using one of a variety of suitable coating methods, for example blade coating, air knife coating, metering rod coating, size press, curtain coating, or another suitable technique. In some examples, the pre-coat and ink-receptive layers can be applied in one single production run, i.e. a pre-coat is applied on a substrate and dried, and then the ink-receptive layer is applied on this pre-coat in the same production run and then dried. In some other examples, the pre-coat and ink-receptive layers are be applied in one single production run simultaneously before drying, i.e. the pre-coat and the ink-receptive layers are applied on the substrate in the same production run and are then dried. In yet some other examples, the pre-coat layer and ink-receptive layers are applied in separated production run. When the pre-coat layer and the ink-receptive layer are present on both sides of the base substrates, depending on set-up of production machine in a mill, both sides of the substrate may be coated during a single manufacture pass, or each side is coated in a separate pass.

In some examples, after the coating step, the media might go through a drying process to remove water and other volatile components present in the coating layers and substrate. The drying pass may comprise several different drying zones, including, but not limited to, infrared (IR) dryers, hot surface rolls, and hot air floatation boxes. In some other examples, after the coating step, the coated web may receive a glossy or satin surface with a calendering or super calendering step. When a calendering step is desired, the coated product passes an on-line or off-line calender machine, which could be a soft-nip calender or a super-calender. The rolls, in the calender machine, may or may not be heated, and certain pressure can be applied to calendering rolls. In addition, the coated product may go through embosser or other mechanical roller devices to modify surface characteristics such as texture, smoothness, gloss, etc.

In some examples, the pre-coat layer is associated with the print media. The phrase “associated with” means that a layer is, for example, formed on, coated on, adsorbed on or absorbed in at least one surface of the print media substrate. The association between a layer and a surface of the print media substrate is achieved by bringing the substrate and composition forming the layer into contact by, for example, spraying, dipping and coating (including, e.g., roll, blade, rod, slot die, or curtain coating).

When the print media substrate is base paper stock, the composition for forming the pre-coat layer can be applied on the base paper stock by an in-line surface size press process such as a puddle-sized press or a film-sized press, for example. In addition to in-line surface sizing processing, off-line coating technologies can also be used to apply the composition for forming the pre-coat layer to the print media substrate. Examples of suitable coating techniques include, but are not limited to, slot die coaters, roller coaters, fountain curtain coaters, blade coaters, rod coaters, air knife coaters, gravure applications, and air brush applications, for example.

### Method for Producing Printed Images

The method for producing printed images, or printing method, includes providing a printable recording media such as defined herein; applying an ink composition on the ink-receiving layer of said print media, to form a printed image; and drying the printed image, to provide a printed image with enhanced quality and enhanced image permanence. In some examples, the print speed of the printing method is more than about 50 feet per minute (fpm). In some other examples, the ink composition is applied onto the recording media via inkjet nozzles.

The printable recording media contains a base substrate; a pre-coat layer including more than about 60 wt % of one or more particulate inorganic pigments by total dry weight of said pre-coat layer; an ink-receiving layer, disposed on said pre-coat layer, comprising a mixture of about 10 to about 90 wt % of a first pigment including precipitated calcium carbonate particles, about 5 to about 60 wt % of a second pigment having a larger size and a different shape than said first pigment particles, and about 1 to about 50 wt % of a third pigment having a surface area of at least 50 m²/gram, wherein said weight percentages are by combined weight of the first, second and third pigments by total dry weight of said ink-receiving layer.

An example of the printing method in accordance with the principles described herein, by way of illustration and not limitation, is shown in FIG. 3. FIG. 3 illustrates embodiments of the printing method that encompasses providing a printable recording media, applying an ink composition onto said a printable recording media and obtaining a printed article.

In some examples, the printing method for producing images is an inkjet printing method. By inkjet printing method, it is meant herein a method wherein a stream of droplets of ink is jetted onto the recording substrate or media to form the desired printed image. The ink composition may be established on the recording media via any suitable inkjet printing technique. Examples of inkjet method include methods such as a charge control method that uses electrostatic attraction to eject ink, a drop-on-demand method which uses vibration pressure of a piezo element, an acoustic inkjet method in which an electric signal is transformed into an acoustic beam and a thermal inkjet method that uses pressure caused by bubbles formed by heating ink. Non-limitative examples of such inkjet printing techniques include thus thermal, acoustic and piezoelectric inkjet printing. In some examples, the ink composition is jetted onto the recording media using an inkjet nozzle and/or an inkjet printhead. In some other examples, the ink composition is applied onto the recording method using thermal inkjet printheads.

The printing method described herein can be a high-speed printing method. By high speed, it is meant a method capable of printing at a speed of more than 50 of feet per minute (fpm). The web-speed could be from about 100 to about 4 000 feet per minute (fpm). In some other examples, the printing method is a printing method capable of printing from about 100 to about 1 000 feet per minute. In yet some other examples, the printing method is capable of printing at a web-speed of more that about 200 feet per minute (fpm).

In some example, the printing method is a high-speed web press printing method. As “web press”, it is meant herein that the printing technology encompasses an array of inkjet nozzles that span the width of the paper web. The array is thus able, for example, to print on 20″, 30″, and 42″ wide web or on rolled papers.

In some examples, the printing method as described herein prints on one-pass only. The paper passes under each nozzle and printhead only one time as opposed to scanning type printers where the printheads move over the same area of paper multiple times and only a fraction of total ink is use during each pass. The one-pass printing puts 100% of the ink from each nozzle/printhead down all at once and is therefore more demanding on the ability of the paper to handle all of the ink in a very short amount of time.

As mentioned above, a print media in accordance with the principles described herein may be employed to print images on one or more surfaces of the print media. In some examples, the method of printing an image includes depositing ink that contains particulate colorants. A temperature of the print media during the printing process is dependent on one or more of the nature of the printer, for example. Any suitable printer may be employed such as, but not limited to, offset printers and inkjet printers. In some examples, the printer is a HP T350 Color Inkjet Webpress printer (Hewlett Packard Inc.). The printed image may be dried after printing. The drying stage may be conducted, by way of illustration and not limitation, by hot air, electrical heater or light irradiation (e.g., IR lamps), or a combination of such drying methods. In order to achieve best performances, it is advisable to dry the ink at a maximum temperature allowable by the print media that enables good image quality without deformation. Examples of a temperature during drying are, for examples, from about 60° C. to about 205° C., or from about 120° C. to about 180° C. The printing method may further include a drying process in which the solvent (such as water), that can be present in the ink composition, is removed by drying. As a further step, the printable recording media can be submitted to a hot air drying systems. The printing method can also encompass the use of a fixing agent that will retain with the pigment, present in the ink composition that has been jetted onto the media.

### EXAMPLES

### Ingredients

TABLE 1

| Ingredient name | Nature of the ingredient | supplier |
|---|---|---|
| Opacarb ®A40 | precipitated calcium carbonate pigment | BASF |
| | (average particle size of 0.4 μm) | |
| Kaocal ® | calcined clay | Thiele Kaolin Company |
| Sylojet ®A25 | silica dispersion | Grace Davison |
| Latex PT9525 | water-dispersible latex binder | Omnova |
| GenCryl ®PT9525 | water-dispersible latex binder | Omnova |
| Mowiol ®4-98 | water-soluble polymer-polyvinyl alcohol | Sigma-Aldrich |
| Deairex ®3040 | defoamer | Ashland |
| EkaFlow ®L265 | rheology modifier | Eka Chemicals |
| Dispex ®N40V | Dispersant | BASF |
| Hydribrite ®TS100 | Optical Brightener | Hydrite Chemical |

### Example 1

### Coating Layer Formulations

The formulations of the pre-coat layer and of the ink-receptive layer are expressed in the Table 2. Each number represents the parts of each component, present in each layer, based on 100 parts of inorganic pigments and based on amount of dry chemicals.

TABLE 2

| | |
|---|---|
| Ingredients | parts |

Pre-coat layer

| | | |
|---|---|---|
| Kaocal ® | 60 | parts |
| Opacarb ® A40 | 40 | parts |
| Latex PT9525 | 14 | parts |
| Dispex ®N40V | 0.12 | parts |
| Mowiol ® 4-98 | 1 | part |
| Hydribrite ®TS100 | 0.08 | part |
| EkaFlow ® L265 | 0.075 | parts |

Ink-receptive layer

| | | |
|---|---|---|
| Kaocal ® | 50 | parts |
| Opacarb ® A40 | 40 | parts |
| Sylojet ® A25 | 10 | parts |
| Gencryl ® 9619 | 14 | parts |
| Deairex ® 3040 | 0.2 | parts |
| Mowiol ® 4-98 | 0.5 | parts |
| EkaFlow ® L265 | 0.2 | parts |

### Example 2

### Printable Recording Media

In compositions listed in Table 2, chemicals are mixed together in a tank by using normal stirring equipment. The composition for forming the pre-coat layer is applied to both surfaces of a raw base paper (such as illustrated in Table 3) by a metering size press, and then dried. The composition for forming the ink-receptive layer is coated by using a flooded nip applicator pilot blade coater and is applied on both sides of the recording media, above the pre-coat layer (such as illustrated in Table 3). The recording media is then calendered through a two-nip soft nip calendering machine (at 100 kN/m, 54.4° C. (130° F.).

The Table 3 illustrates the printable recording media that are obtained accordingly. Recording media 1 and 2 are control examples as they do not contain any pre-coat layer.

TABLE 3

| | Pre-coat layer | Ink-receptive layer |
|---|---|---|
| Recording media # | coat-weight in gsm | coat-weight in gsm |
| recording media 1 | 0 | 15 |
| recording media 2 | 0 | 19 |
| recording media 3 | 10.5 | 15 |

### Example 3

### Printing Method and Recording Media Performances

An identical image sequence is printed on the recording media 1, 2 and 3, obtained as illustrated in Table 3, using a HP T350 Color Inkjet Webpress (Hewlett Packard Inc.). Such printer contains HPA10 printheads filed with HPA10 inks. The web-speed for the printing process is about 400 fpm. The settings on web press are “COLOR100_NORMAL_BOOK_V2_{—}0 profile”; both print side 1 and print side 2, dryers are set at 370° F. and 10,000 fpm air velocity.

The roughness of the unprinted article is measured using PPS (Parker Print-Surf) tester. In addition, several tests and measurements are made on the resulting printed article (print mottle, bleed, Color gamut, KOD and durability). Such results are illustrated in Table 4.

Gamut Measurement represents the amount of color space covered by the ink on the media. Gamut volume is calculated using L*a*b* values of 8 colors (cyan, magenta, yellow, black, red, green, blue, white) measured with an X-RITE®939 Spectro-densitometer (X-Rite Corporation), using D65 illuminant and 2° observer angle.

The black optical density (KOD) measures the reflectance of the area filled using an X-RITE®939 Spectro-densitometer. The higher the KOD value is, the darker the black colored image is obtained.

Bleed testing is carried out with a bleed stinger pattern. 1016 micron lines (or 40 mil, where 1 mil= 1/1000^{th} of an inch) of cyan, magenta, yellow, black, red, green, blue inks, passing through solid area fills of each color, are printed and scanned.

The durability is tested immediately after printing (0 H) and at 24 hours (24 H) after printing. The testing items include dry finger rub, wet finger rub, dry finger print, wet finger print, rub by using an eraser, and rub with a blank media surface against the image. Each durability testing item is then given a rating score from 1 to 5, where 1 means the worst performance (all the ink in the image has been removed), and 5 represents the best performance (the image shows no damage). The durability results show the average durability scores of each sample, as an overall durability performance score.

Print mottle is evaluated by visual comparison.

TABLE 4

| | recording | recording | recording |
|---|---|---|---|
| Testing Results | media 1 | media 2 | media 3 |
| PPS Roughness (μm) | 2.1 | 2.3 | 2.0 |
| Print Mottle | Significant mottle | Some mottle | No mottle |
| Bleeding | fair | Good | Good |
| Color Gamut | 189630 | 186211 | 183686 |
| KOD | 1.51 | 1.51 | 1.51 |
| Durability at 0 H | 4.75 | 4.67 | 4.50 |
| Durability at 24 H | 4.75 | 4.75 | 4.75 |

The results demonstrate that the printable recording media according to the present disclosure does not show visible print mottles in images printed on an HP Web Press T350 while maintaining good printing properties (good bleeding, color gamut, KOD and durability performances).

1. A printable recording media comprising:
a. a base substrate;
b. a pre-coat layer including more than about 60 wt % of one or more particulate inorganic pigments by total dry weight of said pre-coat layer;
c. an ink-receiving layer, disposed on said pre-coat layer, comprising a mixture of:
i. about 10 to about 90 wt % of a first pigment including precipitated calcium carbonate particles,
ii. about 5 to about 60 wt % of a second pigment having a larger size and a different shape than said first pigment particles, and
iii. about 1 to about 50 wt % of a third pigment having a surface area of at least 50 m²/gram,
wherein said weight percentages are by combined weight of the first, second and third pigments by total dry weight of said ink-receiving layer.

2. The printable recording media of claim 1 wherein the particulate inorganic pigments, present in the pre-coat layer, are precipitated calcium carbonate, modified calcium carbonate, ground calcium carbonate, kaolin clay, hydrated clay, engineered clay, calcined clay or a mixture of any of them.

3. The printable recording media of claim 1 wherein the particulate inorganic pigments, present in the pre-coat layer, are combinations of calcined clay and precipitated calcium carbonate.

4. The printable recording media of claim 1 wherein the pre-coat layer comprises one or more polymeric binder in an amount representing from of about 2 wt % to about 25 wt % by total dry weight of the pre-coat layer.

5. The printable recording media of claim 1 wherein the first pigment, of the ink-receiving layer, is present in an amount representing from about 25 to about 75 wt % of the total weight of said ink-receiving layer.

6. The printable recording media of claim 1 wherein the second pigment, of the ink-receiving layer, is present in an amount representing from about 10 to about 50 wt % of the total weight of said ink-receiving layer.

7. The printable recording media of claim 1 wherein the second pigment, of the ink-receiving layer, is a combination of ground calcium carbonate particles and platey clay.

8. The printable recording media of claim 1 wherein the third pigment, of the ink-receiving layer, is present in an amount representing from about 5 to about 40 wt % of the total weight of said ink-receiving layer.

9. The printable recording media of claim 1 wherein the third pigment presents in the ink-receiving layer is silica pigment.

10. The printable recording media of claim 1 wherein the ink-receiving layer further comprises a polymeric binder in an amount representing from about 2 wt % to about 20 wt % by total dry weight of the ink-receiving layer.

11. The printable recording media of claim 1 wherein the ink-receiving layer has a coat weight of at least 15 gsm on at least one side of said media.

12. The printable recording media of claim 1 wherein the coat-weight of the pre-coat layer, on a side of the printable recording media, is of about 5 to about 20 gsm and the coat-weight of the ink-receiving layer, on the same side of the printable recording media, is of about 15 to about 30 gsm.

13. A method for producing printed images comprising:
a. obtaining a printable recording media containing a base substrate; a pre-coat layer including more than about 60 wt % of one or more particulate inorganic pigments by total dry weight of said pre-coat layer; an ink-receiving layer, disposed on said pre-coat layer, comprising a mixture of about 10 to about 90 wt % of a first pigment including precipitated calcium carbonate particles, about 5 to about 60 wt % of a second pigment having a larger size and a different shape than said first pigment particles, and about 1 to about 50 wt % of a third pigment having a surface area of at least 50 m²/gram, wherein said weight percentages are by combined weight of the first, second and third pigments by total dry weight of said ink-receiving layer;
b. applying an ink composition on the ink-receiving layer of said print media, to form a printed image; and
c. drying the printed image, to provide a printed image with enhanced quality and enhanced image permanence.

14. The method of claim 13 wherein the print speed is more about 50 feet per minute (fpm).

15. The method of claim 13 wherein the ink composition is applied onto the printable recording media via inkjet nozzles.
